(19) United States
(12) Patent Application Publication
(10) Pub. No.: US 2011/0153198 A1
(43) Pub. Date: Jun. 23, 2011

(54) Method for the display of navigation instructions using an augmented-reality concept

(75) Inventors: Nikolaos Kokkas, Nottingham (GB); Jochen Schubert, Irvine, CA (US)

(73) Assignee: Navisus LLC, wilmington, DE (US)

(21) Appl. No.: 12/961,279

(22) Filed: Dec. 6, 2010

Related U.S. Application Data
(60) Provisional application No. 61/288,693, filed on Dec. 21, 2009.

(51) Int. Cl. G01C 21/00

(52) U.S. Cl. 701/201; 701/200

(57) ABSTRACT

A method with which navigation instructions are displayed on a screen. Preferably, using an augmented-reality approach whereby the path to the destination and 3D mapping objects such as buildings and landmarks are highlighted on a video feed of the surrounding environment ahead of the user. The invention is designed to run within embodiments the likes of Personal Digital Assistants (PDAs), smartphones or in-dash vehicle infotainment systems, displaying in real-time a video feed of the path ahead while superimposing transparent cartographic information with navigation instructions. The aim is to improve the user's navigation experience by making it easier to relate to the real world with 3D maps and representative navigation instructions. This method makes it safer to view the navigation screen and the user can locate landmarks, narrow streets and the final destination more easily.

### BACKGROUND OF THE INVENTION

1. Field of the Invention

The invention generally relates to a method with which navigation instructions are displayed on a screen. Preferably, using an augmented-reality approach whereby the path to the destination is marked on a video feed of the surrounding environment ahead of the user.

Conventional navigation systems present abstractions of navigation data: they either show a flat arrow indicating a turn or pointing in the required direction, or they present an overcrowded bird's eye view of a geographical map and the driver's current position and orientation on it. Regardless of which method is used, the information presented is not clear and demands the ability to abstract. This creates a fundamental problem; consumers have to relate the navigation instructions to what they see in the real-world. They often misinterpret junction exits, turning points and have difficulties identifying their exact destination. Many times accidents are reported because users try to decipher the navigation screen while driving.

2. Summary of the Invention and Advantages:

The invention relates navigation instructions to the user based on what is seen in the real-world. Therefore it allows easier navigation conducive to enhanced safety. The invention is designed to run within embodiments the likes of Personal Digital Assistants (PDAs), smartphones or in-dash vehicle infotainment systems, displaying in real-time a video feed of the path ahead while superimposing transparent cartographic information with representative navigation instructions.

Generally the method presented in this patent application has the following distinguishing and novel characteristics in comparison to previous patents relating to augmented reality navigation:
Use of full, spatially variable, 3D terrain information integrated within the road network, buildings and landmark geometries. This reduces data storage requirements and processing demands.
Reliance on a wider and more complete set of sensors capable of achieving high-accuracy positioning and orientation thus making the system suitable not only for vehicle navigation but also for pedestrian navigation.
Implementation of a method to relate the user's position to a three-dimensional path centerline maintaining high level of positional accuracy even during weak GNSS signal.
Implementation of camera calibration parameters: a process for calibrating the video sensor so that important characteristics such as lens distortions and focal length are accounted for when undertaking graphical processing. This improves the accuracy of overlaying navigation related data onto the live video feed.
Implementation of the collinearity condition to accurately model the relationship between the 3D object space and image space and transfer 3D maps and navigation instruction on the CCD array of pixels, thus ensuring an optimum registration with the real time video feed for augmented reality navigation.

Prior patents related to augmented reality navigation:

U.S. Pat. No. 7,039,521 B2 where augmented-reality navigation is designed specifically for in-vehicle use. The described method requires a number of sensors, some of which specific to vehicles, thus making the invention unsuitable to portable electronic devices. Other limitations include the method for visualizing driving instructions i.e. projecting arrows, and restricted use of 3D geospatial data. In addition no attempts are made to model camera distortions to reduce misalignment between video-feed and data.

WO 2008/138403 A1 The invention describes a system that displays directional arrows for turning instructions on a video feed of the road ahead. Contrary to the method described in this patent, the invention is limited to only the use of geographic position from GPS satellites to generate the bearing of the arrows. As the invention does not rely on 3D maps or orientation information from a digital compass, the invention is limited to displaying simple turn directions without achieving real superimposition on the video feed. Furthermore the invention does not model the camera geometry, lens distortions are not accounted for and no technique is described to improve the positional accuracy of the GPS sensor in urban environments.

KR 20070019813 A This invention is similar to the previous patent, WO 2008/138403, since the use of two-dimensional mapping data is not conducive to achieve accurate superimposition of essential navigation content such as POIs and route paths on the video feed

KR 20040057691 A The invention describes a system using only positional information to display an arrow for turning directions on a car windshield. No orientation sensor is used thus limiting the invention to simple turn indications. In addition only 2D mapping data are used to represent POIs, roads and buildings so the field of view of the driver is only partially augmented. This invention can only be used for in-vehicle navigation, contrary to the proposed navigation method which can be utilized in smartphones and mobile devices for pedestrian navigation also.

CN 101339038 A This invention describes a system that uses positional information and image matching techniques to match a 3D road geometry with the video feed of the road ahead. Contrary to the proposed method in this patent, the invention does not use or rely on orientation information to determine the pointing direction of the camera. The matching of the road features with the video is achieved using image processing techniques which are known to be computationally demanding and are generally more suitable for powerful processors found for example in in-dash navigation devices but not on smartphones. In addition this invention does not account for lens distortions and no further processes are described for modelling and minimising positional errors from the GPS receiver.

EP 1460601 A1 This invention is very similar to patent WO 2008/138403 as again it implies the use of only a GPS sensor for the generation of the turn arrow on top of the video feed of the road ahead. The differences to the method presented in this document are the same as those outlined for patent WO 2008/138403 and include the limitation of the device only being designed for in-dash use. In addition the invention does not specify the use of Kalman filtering or any other photogrammetric or statistical method to improve positional accuracy, and the camera geometry is not modelled and accounted for when superimposing features on the video. This invention is again limited to in-dash car navigation use.

WO 2007/101744 A1 This invention describes a method for the display of navigational directions tailored for in-vehicle navigation. It relies on processing intensive image matching algorithms and does not address the issues with the accuracy of superimposition of 3D maps on the video feed.

EP 0406946 B2 This invention is similar to patent WO 2008/138403 and EP 1460601 as it relies on a user's position to display static directional arrows projected onto a video feed, therefore achieving a different implementation of augmented reality. The invention is designed for in-dash car navigation use only.

US 2001/0051850 A1 This invention is based on a conventional navigation system for in-vehicle use only, which is augmented using a pattern recognition system updating the driver with relevant automotive information by detecting and interpreting street signs and traffic conditions ahead of the vehicle.

References Cited:
EP 1460601 A1: Mensales, Alexandre. “Driver Assistance System for Motor Vehicles”. Patent EP 1460601 A1. 14 Apr. 2007
EP 0406946 B2: de Jong, Durk Jan. “Method of displaying navigation data for a vehicle in an image of the vehicle environment, a navigation system for performing the method, and a vehicle comprising a navigation system”. Patent EP 0406946 B2. 18 Jul. 2007
US 2001/0051850 A1: Wietzke Joachim and Lappe Dirk. “Motor Vehicle Navigation System With Image Processing”. Patent US 0051850 A1. 13 Dec. 2001
US 2006/7039521 B2: Hörtner Horst and Kolb Dieter, Pomberger Gustay. “Method and device for displaying driving instructions, especially in car navigation systems”. U.S. Pat. No. 7,039,521 B2. 2 May 2006
WO 2007/101744 A1: Mueller Mario. “Method and System for Displaying Navigation Instructions”. Patent WO 2007/101744 A1. 13 Sep. 2007
WO 2008/138403 A1: Bergh Jonas and Wallin Sebastian. “Navigation Assistance Using Camera”. Patent WO 2008/138403 A1. 20 Nov. 2008
KR 20040057691 A: Kim Hye Seon, Kim Hyeon Bin, Lee Dong Chun and Park Chan Yong. “System for Navigating Car by Using Augmented Reality and Method for the same Purpose”. Patent KR 20040057691 A. 2 Jul. 2004
CN 101339038 A: Zhaoxian Zeng. “Real Scene Navigation Apparatus”. Patent CN 101339038 A. 7 Jan. 2009
Brown, R. and Hwang, P. Y. C, 1997. Introduction to Random Signals And Applied Kalman Filtering, John Wiley & Sons Inc., New-York
Caruso, M. J., Bratland, T., Smith, C. H., Schneider, R., 1998. “A New Perspective on Magnetic Field Sensing”, Sensors Expo Proceedings, October 1998, 195-213.
Fraser, C. S., 1997. Digital camera self-calibration, ISPRS Journal of Photogrammetry and Remote Sensing, Vol. 52, pp. 149-159
Fraser, C. S. and Al-Ajlouni, S., 2006. Zoom-dependent camera calibration in digital close-range photogrammetry. PE&RS, Vol. 72, No. 9, pp. 1017-1026
Gabaglio, V., Ladetto, Q., Merminod, B., 2001. Kalman Filter Approach for Augmented GPS Pedestrian Navigation. GNSS, Sevilla.
Merminod, B., 1989. The Use of Kalman Filters in GPS Navigation, University of New South Wales Sydney
Van Sickle, J., 2008. GPS for land surveyors, Third Edition, CRC Press

### Intended Use:

The intended use of the invention is that of in-vehicle as well as personal navigation, mainly but not limited to urban areas due to the flexible 2D/3D navigation instruction display. The superior clarity with which navigation instructions are visually conveyed to the user can improve driving safety as well as reduce the possibility of missing a turn or destination. Navigation instructions for in-vehicle navigation can be displayed on a screen of an in-dash infotainment system, while Personal navigation is achieved by displaying navigation information using available smartphones and PDAs which have the required sensors such as those shown in FIG. 1.

### DESCRIPTION OF THE DRAWINGS

The invention is further described through a number of drawings which schematize the technology. The drawings are given for illustrative purposes only and are not limitative of the presented invention.

FIG. 1 shows a diagram of overall system architecture with inputs and outputs.

FIG. 2 shows a diagram representing the integration of the digital compass, GNSS and imaging sensor on a mobile platform.

FIG. 3 shows a diagram representing the perspective model for reconstructing the internal geometry of the imaging sensor.

FIG. 4 shows a diagram to clarify how the user's x,y position is related to the road network.

FIG. 5 shows a diagram to clarify how the user's z position is related to the road network.

FIG. 6 shows a general diagram for the generation of 3D object data and their integration into the display of augmented-reality navigation information.

FIG. 7 shows a diagram representing the model for conversion of the 3D object space into image space to ensure optimum registration between 3D navigation instruction and the real time video feed.

### DETAILED DESCRIPTION OF THE INVENTION

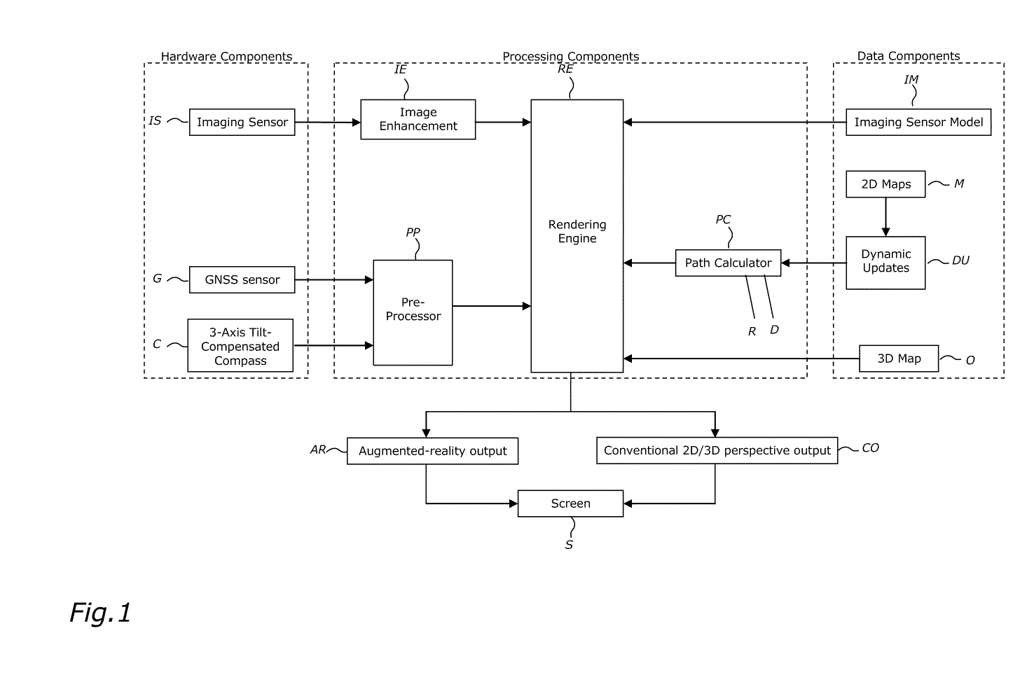

The invention is designed to provide augmented-reality navigation as described in FIG. 1. The diagram schematizes the methodology subdividing it into its primary three components: hardware, data, and processing and shows how a route R is calculated by inputting a destination D into the path calculator PC. The path calculator PC calculates the most suitable route R, using a 2D map M, updating it dynamically DU as information causing road-blocks and traffic is received. The computed route R is then inputted into the rendering engine RE.

### Obtaining Position

The user's positional information is gathered by a GNSS receiver G (FIG. 1) using a pseudorange measurement p to at least four GNSS satellites as described in Eq. 1:

p=ρ+c(dt−dT)+dᵢₒₙ+dₜᵣₒₚ+εₚ (1)

where ρ is the true range between satellite and receiver, c is the speed of light, dt is the satellite clock offset from GNSS time, dT is the receiver clock offset from GNSS time, dᵢₒₙ is the ionospheric delay, dₜᵣₒₚ is the tropospheric delay and εₚ represents other biases such as multipath, receiver noise, etc. (Van Sickle, 2008). In order for the user's positional information to be established using several GNSS networks (GPS, Galileo, GLONASS etc.) simultaneously, satellite and receiver clock offsets to GNSS time have to be established for each GNSS network respectively. Assisted GPS (aGPS) further allows to resolve delays caused by the atmosphere and other biases.

### Obtaining Orientation

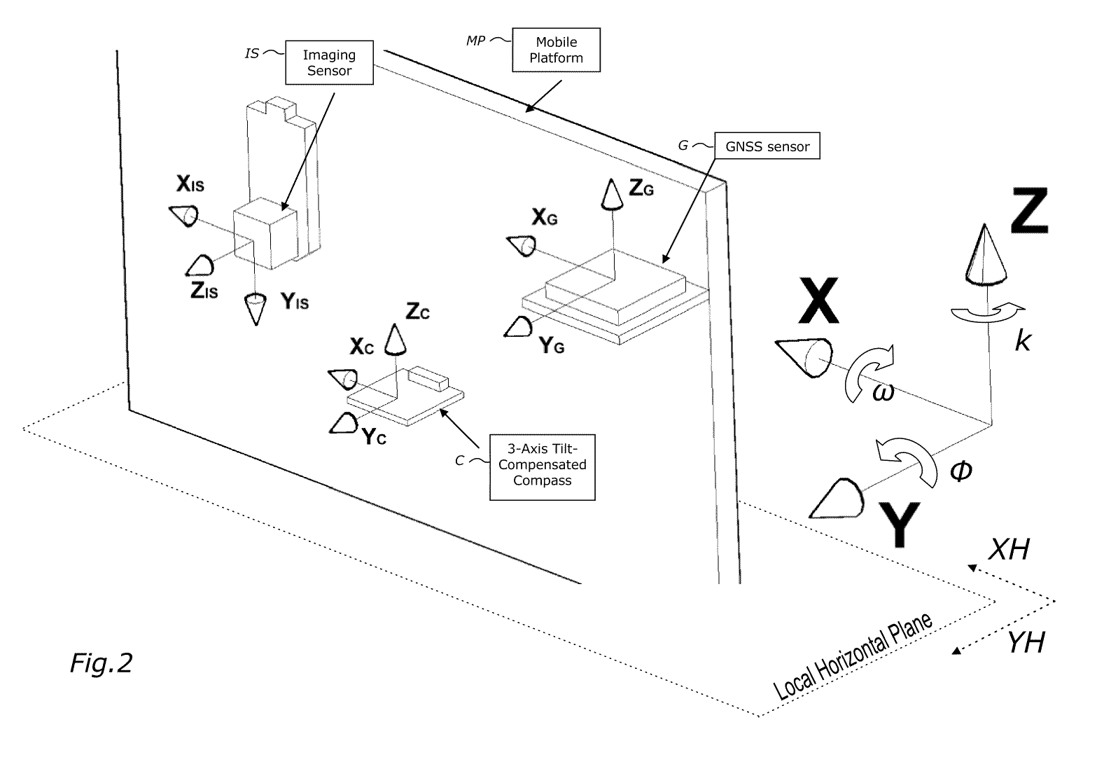

Orientation of the user is established by a 3-axis tilt-compensated compass C as shown in FIG. 1. Tilt compensation is necessary to allow the compass, built into a mobile platform MP shown in FIG. 2, to function beyond its horizontal plane (equivalent to the earth's horizontal magnetic field components XH, YH) as it is moved by a user. FIG. 2 illustrates the tilt angles for roll (ω) and pitch (φ) of a user, which occur along the Xc and Yc axis as shown in FIG. 2. When the digital compass C experiences a tilt the Xc, Yc, Zc magnetic readings are transformed to the compass's C original horizontal plane (XH, YH) by applying Eq. 2 and Eq. 3:

XH=Xc cos(φ)+Yc sin(ω)−Zc cos(ω) sin(φ) (2)

YH=Yc cos(φ)+Zc sin(ω) (3)

az=arcTan(YH/XH) (4)

Once the magnetic components are found in the horizontal plane, Eq. 4 is used to compute the compass's azimuth az from the corrected Xc and Yc readings. (Caruso and Smith, 1998)

### Improving Quality of Position and Orientation

User current position and orientation are further processed using a pre-processor PP, shown in FIG. 1, in order to improve the overall quality of position and azimuth, by applying an extended Kalman filter.

The improvement of the azimuth as given by the digital compass C is achieved by taking into account any deviation between the magnetic north with the true north. This is of critical importance since the azimuth of the compass C, as given by Eq. 4, is related to the magnetic north but the navigation instructions and 3D maps use the true north. Thus the pre-processor PP ensures the magnetic north azimuth, as given by Eq. 4, is converted to a true north azimuth by computing the magnetic declination. The value of the magnetic declination differs depending on the position of the user, thus the latitude, longitude and elevation obtained from the GNSS sensor G are used in conjunction with a lookup table containing the varying magnetic declination values for different geographic areas. The lookup table is based on the coefficients given by the International Geomagnetic Reference Field (IGRF10). After the true north azimuth is estimated, the orientation data are given as 3 rotation angles (ω, φ, κ) that represent the roll, pitch and yaw angles respectively. These rotation angles are also shown in FIG. 2 as clockwise rotations around the X, Y and Z axes respectively.

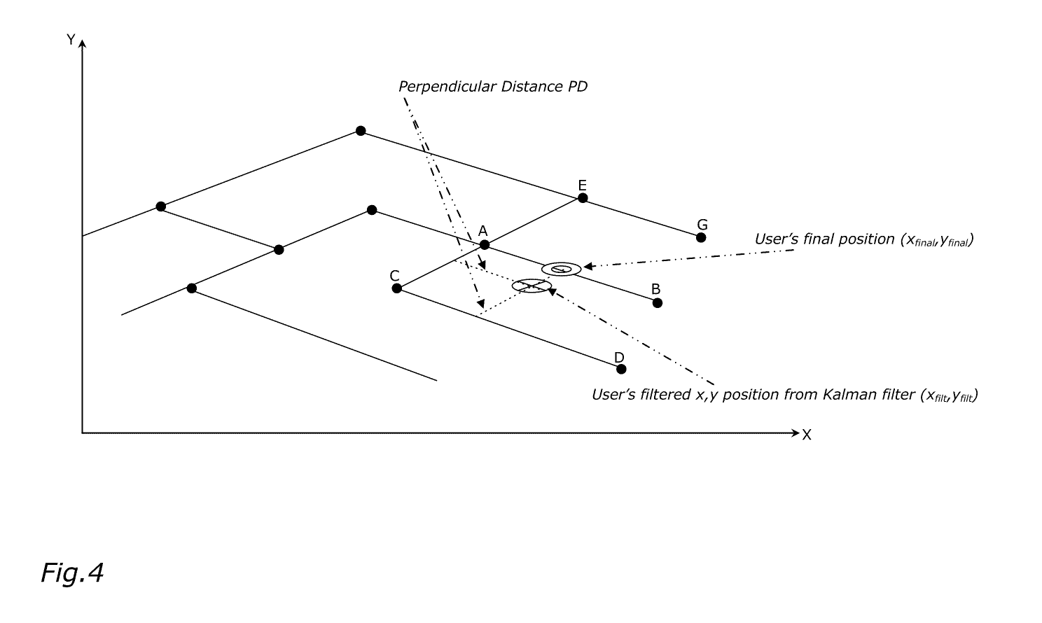

Improving the initial position is achieved in three ways, first the GNSS receiver G is designed to receive positioning data from GNSS constellations including but not limited to GPS, GLONASS and Galileo, second by applying an extended Kalman filter running a Dead-Reckoning integration between the GNSS sensor G and digital compass C, and third by relating the filtered position as estimated from the Kalman filter to a mapped 3D road network or path as shown in FIG. 4. We refer to the initial position as the raw latitude, longitude, height values given by the GNSS position. The filtered position is the one obtained after the implementation of the extended Kalman filter. The final position is the one obtained after relating the filtered position to the mapped 3D road network.

The Kalman filter is implemented in a dead-reckoning algorithm that integrates the GNSS receiver G with the compass C by taking into account the errors, biases and raw values obtained by the gyroscopes, accelerometers and the single frequency GNSS receiver G as described by Gabaglio et al, 2001. The gyroscopes and accelerometers are components of the 3-axis tilt-compensated compass C.

The orientation determined by the gyroscopes is computed according to Eq. 5.

φₜ=φₜ₋₁+dt·(λ·ω+b) (5)

φₜ: is the orientation at time t

If t=0, φ₀ is the initial orientation

λ: is the scale factor
b: is the bias
ω: is the measured angular rate
dt: is the time interval over which a distance and an azimuth are computed

The scale factor, bias and initial orientation φₒ are parameters to be estimated. The azimuth determined by the magnetic compass is computed according to Eq. 6.

φₜ=azₜ+ƒ(b)+δ (6)

azₜ: is the measured azimuth at time t
ƒ(b): is the bias, in this case it is a function of the local magnetic disturbance
δ: is the magnetic declination

Since the magnetic declination is corrected in the previous stage, the bias b can be considered as the function of soft and hard magnetic disturbances. The mechanization of the Dead-Reckoning algorithm takes into account Eq. 5 and Eq. 6 which are used to furnish the navigation parameters below:

Nₜ=Nₜ₋₁+distₜ·cos(φₜ)

Eₜ=Eₜ₋₁+distₜ·sin(φₜ) (7)

### Where

N, E: are the North and East coordinates
φₜ: is the azimuth
distₜ=s·dt
s: the speed computed with the acceleration pattern
dt: is the time interval over which a distance and an azimuth are computed

The extended Kalman filter adopted in this invention's methodology minimizes the variance between the prediction of parameters from a previous time instant and external observation at the present instant (Brown and Hwang, 1997). This invention adopts a kinematic model and an observation model, each one having a functional and a stochastic part.

The functional part of the kinematic model represents the prediction of the parameters. The parameters in the GNSS/compass system form the vector shown in Eq. 8.

X^{T}=[ENφbλAB] (8)

Where A and B are the parameters of the distance model. Considering the increments of the parameters, the state vector is:

dX^{T}=[dEdNdφdbdλdAdB] (9)

Then the functional part of the model is

d\tilde{x}ₜ=Φₜ·d\tilde{x}ₜ₋₁+w (10)

Where Φ is the transition matrix and w is the system noise, assumed to have a mean of zero and no correlation with the components of dx.

During the mechanization stage, the stochastic part of the model is obtained via variance propagation.

C_{\tilde{x}\tilde{x}t}=Φ_{κ}·C_{\tilde{x}\tilde{x}t-1}·Φₜ^{T}+C_{ww} (11)

Where the C_{\tilde{x}\tilde{x}k} matrix contains the variance of the predicted parameters at time t and C_{ww} is the covariance matrix of the process noise.

The observation model takes into account the indirect observation of the GNSS receiver (l_{E} and l_{N}) and the GNSS azimuth (l_{φ}). These observations form the observation vector lₜ which is a function of the parameters shown in Eq. 12.

lₜ−v=ƒ(x) (12)

Where v represents the vector of residuals in observations of the GNSS receiver G. After linearization around the mechanized values Eq. 12 becomes:

\tilde{v}ₜ−v=H·dx (13)

Where

\tilde{v}ₜ=lₜ−ƒ(\tilde{x}ₜ) is the vector of predicted residuals (observed minus computed term) (14)
\tilde{x}ₜ is the vector of the mechanized parameters at the observation time t
H is the design matrix

The vector \tilde{v}ₜ in Eq. 14 represents the difference between the GNSS position and azimuth and the Dead-Reckoning output after mechanization.

The update stage in the Kalman filter is an estimation that minimizes the variance of both the observations and the mechanization models (Gabaglio et al, 2001). The update parameters are given by:

d\tilde{x}ₜ=Kₜ·\tilde{v}ₜ(15)

\hat{x}ₜ=\tilde{x}ₜ+Kₜ·\tilde{v}ₜ (16)

Where \tilde{x}ₜ denotes the mechanized parameters at time t. The ‘hat’ denotes an estimate and the ‘tilda’ indicates the mechanized value. The gain matrix (Kₜ) can be written as:

Kₜ=C_{\tilde{x}\tilde{x}t}·H^{T}·[H·C_{\tilde{x}\tilde{x}t}·H^{T}+Cₗₗ]⁻¹ (17)

Where Cₗₗ is the covariance matrix of the observations.

Once the updating stage of the Kalman filter is complete the filtered position (X_{filt},Y_{filt},Z_{filt}) is obtained. Note that the elevation (Z_{filt}) is equal to the raw Z value from the GNSS sensor G since the Kalman filter only processes the planimetric co-ordinates.

### Video Acquisition and Camera Calibration

The video acquisition is obtained by the imaging sensor IS which is mounted on the mobile platform as shown in FIG. 2. The Xis,Yis,Zis shown in FIG. 2 define the axes of the imaging sensor which origin corresponds to the lens perspective center assumed to be a single finite point. The Zis axis represents the optical axis of the imaging sensor IS, in other words it represents where the imaging sensor IS is pointing to. The Xis, Yis axes define the two dimensional co-ordinate system of the Charged Coupled Device (CCD) of the imaging sensor IS. The invention integrates the three different sensors IS, G and C by aligning the pointing axis Zis of the imaging sensor IS, with the Yc axis of the compass C and the Y_{G} axis of the GNSS sensor G. These three axes (Zis, Yc, Y_{G}) are parallel as shown in FIG. 2. This system integration and alignment enables accurate determination of the user's position and azimuth/orientation in relation to the video acquisition.

In addition, the invention models the internal geometric characteristics of the imaging sensor IS, referred to as the imaging sensor model IM, in order to enhance the accuracy of the registration between the real-time video feed and the 3D map O.

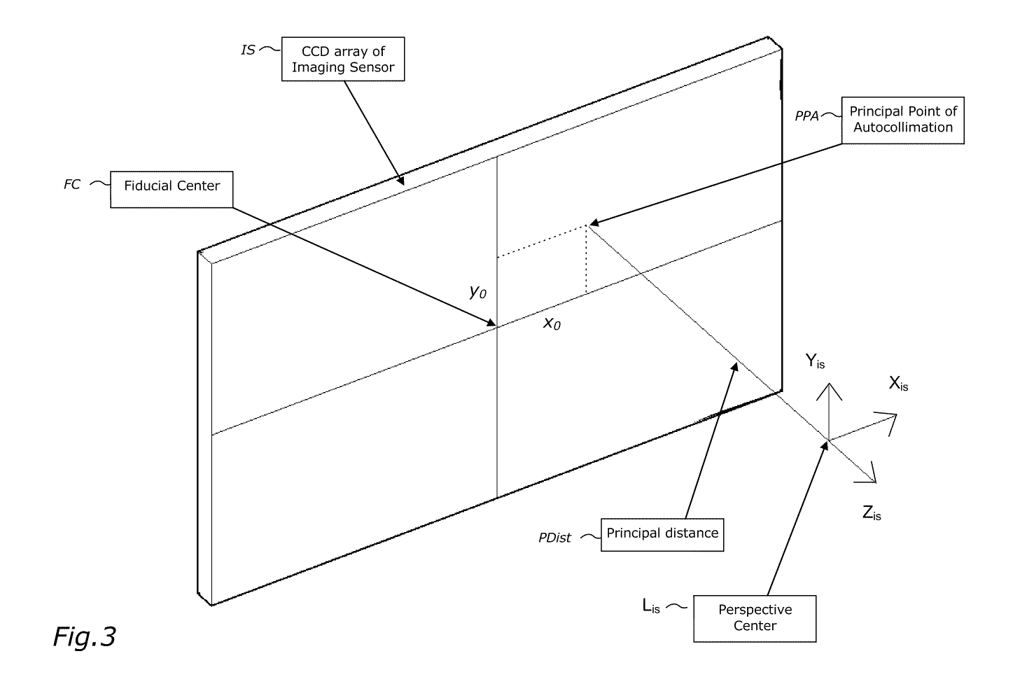

The imaging sensor model IM, as shown in FIG. 1 is commonly referred to in the field of photogrammetry as interior orientation and its purpose is to reconstruct the internal geometry of the imaging sensor IS, and relate the pixel co-ordinate system as defined by the CCD array of pixels to the image co-ordinate system. The image co-ordinate system is represented as shown in FIG. 3 and is defined by the principal point of autocollimation PPA and the Principal Distance PDist. The PPA is formed where the optical axis of the imaging sensor passes through the perspective center L_{IS}. The invention assumes the lens of the imaging sensor is represented by a single point in space, commonly referred to as perspective center L_{IS} where all the light rays are passing through. The principal distance PDist is the distance between the perspective center L_{IS} and the Principal Point of Autocollimation PPA. Because of manufacturing imperfections the PPA is close but does not coincide with the center of the CCD array. The center of the CCD array of pixels is often referred to as Fiducial Center FC as shown in FIG. 3 and the offset between the FC and PPA is represented as (x₀, y₀). When extending the co-ordinates of a point from the pixel array to the image co-ordinate system, it becomes:

(x_{CCD}−x₀,y_{CCD}−y₀,−f) (18)

Where the (x_{CCD},y_{CCD}) are the pixel co-ordinates converted in physical dimension (millimeters) using the manufacturers pixel spacing and pixel count across the X and Y axis of the CCD. The parameter f in Eq. 18 represents the principal distance PDist. The image co-ordinate system has an implicit origin at the perspective center L_{IS} while the pixel coordinate system has its origin at the Fiducial Center FC.

The invention determines the parameters of the interior orientation (x₀, y₀ and f) using a process referred to in the photogrammetry discipline as self-calibration through a bundle block adjustment (Fraser 1997).

In addition the imaging sensor model IM, takes into account radial lens distortions that directly affect the accuracy of the registration between the real-time video feed and the 3D map O. Radial lens distortions are significant especially in consumer grade imaging sensors and introduce a radial displacement of an imaged point from its theoretical correct position. Radial distortions increase towards the edges of the CCD array. The invention models and corrects the radial distortions by expressing the distortions present at any given point as a polynomial function of odd powers of the radial distance as shown below:

dᵣ=k₁r³+k₂r⁵+k₃r⁷ (19)

where:
dᵣ: is the radial distortions of a specific pixel in the CCD array
k₁,k₂,k₃: are the radial distortion coefficients
r: is the radial distance away from FC of a specific pixel in the CCD array

The three radial distortion coefficients are included in the imaging sensor model IM and are also determined through a bundle block adjustment with self-calibration (Fraser and Al-Ajlouni, 2006).

Augmenting Reality with 3D Maps for in-Vehicle and Personal Navigation

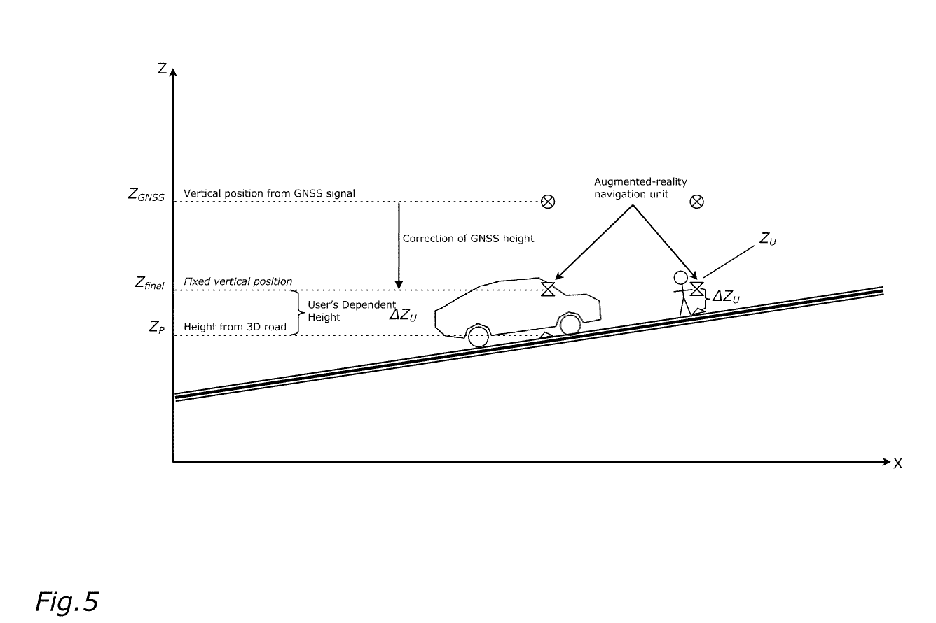

The invention is designed to provide navigation instructions which are limited to a routing network as obtainable from mapping data M. Thus the third and final stage for improving the positional quality is to relate the filtered position (X_{filt},Y_{filt},Z_{filt}) obtained from the pre-processor PP to a mapped 3D road network or path. This is achieved within the rendering engine RE as shown in FIG. 4 for horizontal position and in FIG. 5 for the vertical position. Initially the filtered position (X_{filt},Y_{filt},Z_{filt}) is used as input. For horizontal positioning, path segments whose coordinates do not encompass the user's current position are excluded from further calculation (e.g. FIG. 4 E-G). This is achieved by comparing the coordinates of the filtered position with the co-ordinates of all the line segments stored in a look up table for a geographical sector of 1×1 km² to increase computational efficiency. For the remaining path segments whose co-ordinates do encompass the users current filtered position (e.g. FIG. 4 A-B, C-D) a perpendicular distance PD is calculated as shown in Eq. 20.

$$PD = \pm \frac{{Ax}_{filt} + {By}_{filt} + C}{\sqrt{{A}^{2} + {B}^{2}}} \qquad ( 20 )$$

### Where

(x_{filt}, y_{filt}) is the users filtered horizontal position
Ax+By+C=0 is the line equation for the path segment

The final user's horizontal position (X_{final}, Y_{final}) is then calculated based on the shortest perpendicular distance to the path (e.g. FIG. 4 along A-B). Once the shortest perpendicular distance is selected we get a system of two linear equations:

a₁x+b₁y=c₁ (perpendicular line equation) (21)

a₂x+b₂y=c₂ (path segment for shortest perpendicular line e.g FIG. 4 along A-B) (22)

By solving the values (x, y) that satisfy both Eq. 21 and Eq. 22 we determine the final user's position (X_{final}, Y_{final}). For the user's final vertical position Z_{final} at coordinates (X_{final},Y_{final}) a user nal, final, dependent height ΔZ_{U} is added to the path elevation Z_{P} instead of using the GNSS height Z_{GNSS} (see FIG. 5). The user dependent height ΔZ_{U} varies with vehicle type in which the augmented-reality navigator is used, or the physical height of the user, for the case when augmented-reality navigation is adopted for pedestrian navigation. The user's height from the GNSS Z_{GNSS} (see FIG. 5) is not used during navigation due to the inherent accuracy limitations that GNSS has in urban canyons. The calculations for the user's final horizontal and vertical positioning are undertaken within the rendering engine RE.

To achieve augmented-reality by superimposing 3D maps on the real-time video feed, the final position (X_{final}, Y_{final}, Z_{final}), as well as the orientation values (ω, φ, κ) from the compass C are entered into the rendering engine RE. The imaging sensor IS records the field of view in front of the user, which is enhanced IE by applying brightness/contrast corrections before it is entered into the rendering engine RE (see FIG. 1). To correct for lens distortions in the video feed VE, and model the internal geometry of the imaging sensor IS, camera model IM parameters are inserted into the rendering engine RE.

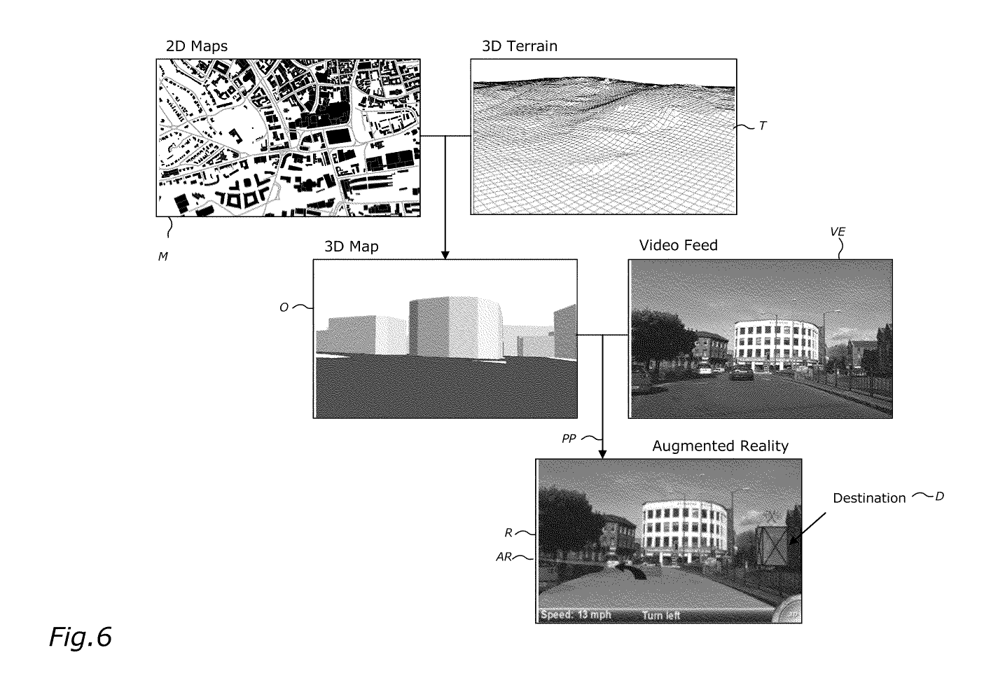

The 3D map O used for drawing the route directions inside the rendering engine RE needs to be three-dimensional for accurate overlay onto the enhanced video feed from the imaging sensor IS, and is produced as shown in FIG. 6. Here map specific information M, such as the road network, is overlaid onto a 3D terrain T and elevation information is extracted to the map specific data to create a 3D map O. Therefore for the display of the 3D map O no extended terrain model T is required as all the necessary terrain topography information is tied to the geographic features of the 3D map O.

The main task of the rendering engine RE is to relate the 3D object space as defined by the 3D map O to the image space as defined by the imaging sensor model IM in real-time, and achieve a sufficient processing performance for smooth visualization. Relating the 3D object space to the image space of the imaging sensor IS enables the accurate registration and superimposition of the 3D map content onto the real-time video feed VE as shown in FIG. 6. This registration is performed with the use of what is referred to in the field of photogrammetry as the collinearity condition.

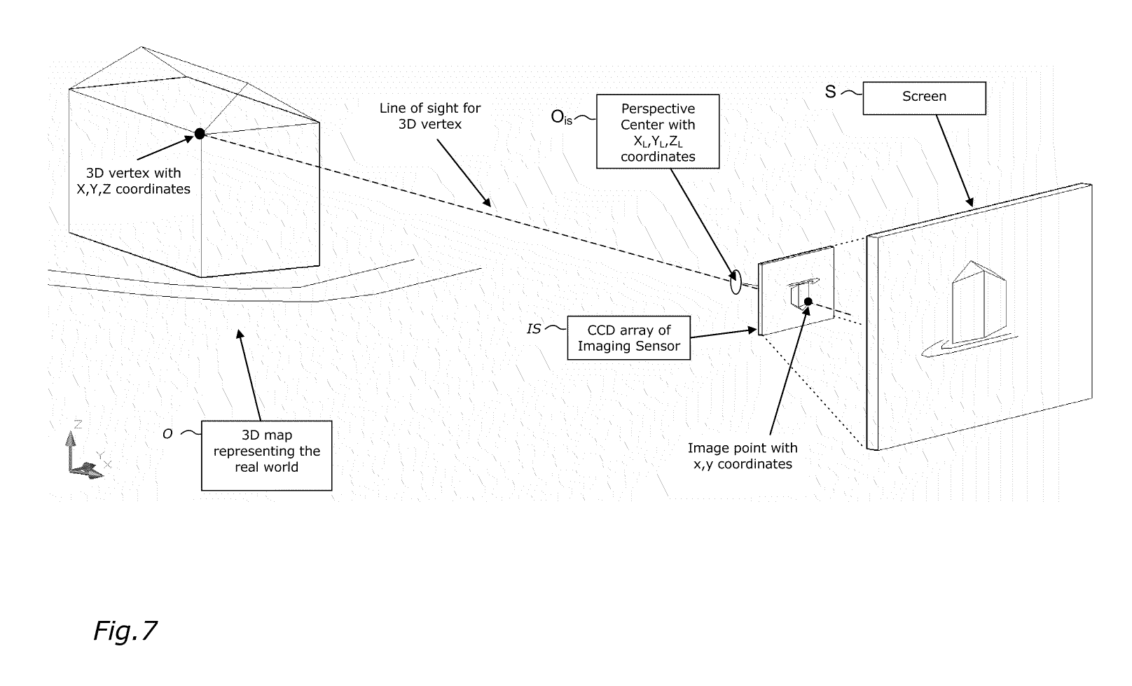

The collinearity condition is the functional model of the imaging system that relates image points (pixels on the CCD Array) with the equivalent 3D object points and the parameters of the imaging sensor model IM. The collinearity condition and the relationship between the screen S, image space and 3D map O is represented in FIG. 7 and is expressed as:

$$x - {x}_{o} = - f \frac{{m}_{11} ( X - {X}_{L} ) + {m}_{12} ( Y - {Y}_{L} ) + {m}_{13} ( Z - {Z}_{L} )}{{m}_{31} ( X - {X}_{L} ) + {m}_{32} ( Y - {Y}_{L} ) + {m}_{33} ( Z - {Z}_{L} )} \\ y - {y}_{o} = - f \frac{{m}_{21} ( X - {X}_{L} ) + {m}_{22} ( Y - {Y}_{L} ) + {m}_{23} ( Z - {Z}_{L} )}{{m}_{31} ( X - {X}_{L} ) + {m}_{32} ( Y - {Y}_{L} ) + {m}_{33} ( Z - {Z}_{L} )} \qquad ( 23 )$$

### Where:

x, y: are the image co-ordinates of a 3D map O vertex on the CCD array
xₒ, yₒ: is the position of the PPA defined by the camera calibration process and included in the imaging sensor model IM
f: is the calibrated principal distance PDist as defined by the camera calibration process and included in the imaging sensor model IM
X, Y, Z: are the coordinates of a 3D vertex as defined in the 3D map O
X_{L}, Y_{L}, Z_{L}: are the coordinates of the perspective center L_{IS} of the imaging sensor IS. These are assumed to be equal with the final user's location (X_{final}, Y_{final}, Z_{final}).

The parameters m₁₁, m₁₂ . . . m₃₃ are the nine elements of a 3×3 rotation matrix M. The rotation matrix M is defined by the three sequential rotation angles (ω, φ, k) given by the compass C. Note that (ω) represents the tilt angle for roll (or clockwise rotation around the X axis), the (φ) represents the tilt angle for pitch (or clockwise rotation around the Y axis), and (k) represents the true north azimuth as calculated in the pre-processor PP module.

The rotation matrix M is expressed as:

$$M = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] \qquad ( 24 )$$

In order for the matrix M to rotate the 3D object co-ordinate system (X, Y, Z) parallel to the image co-ordinate system (x, y, z) the elements of the rotation matrix are computed as follows:

$$M = [ \begin{matrix}cos φcos κ & \begin{matrix}cos ω sin κ + \\ sin ω sin φ cos κ\end{matrix} & \begin{matrix}sin ω sin κ - \\ cos ω sin φ cos κ\end{matrix} \\ - cos φ sin κ & \begin{matrix}cos ω cos κ - \\ sin ω sin φ sin κ\end{matrix} & \begin{matrix}sin ω cos κ + \\ cos ω sin φ sin κ\end{matrix} \\ sin φ & - sin ω cos φ & cos ω cos φ\end{matrix} ] \qquad ( 25 )$$

By substituting all known parameters in Eq. 23 the rendering engine RE computes the image co-ordinates (x, y) of any given 3D map O vertex from the 3D object space to the CCD array. This is performed for each frame. Once the image coordinates are computed the radial distance from the fiducial center FC is determined and the image co-ordinates are corrected for the radial lens distortions using Eq. 26.

xcorrected=x−dr

ycorrected=x−dr (26)

Where dᵣ is the computed radial distortion for the given image point (Eq. 19). Once the corrected image coordinates are computed in the pixel domain a rotation of 180 degrees around the fiducial center FC is applied and subsequently an affine transformation ensures the accurate rendering of the 3D vertices, edges and faces on the screen C as shown in FIG. 7. The affine transformation accounts for any scale differences along the x and y axis between the CCD array and the screen S, normally introduced due to differences in the image/aspect ratio and resolution.

Once the registration is complete the 3D map O and navigation instructions are superimposed with transparent uniform colours on the video feed to create the augmented-reality effect (FIG. 6).

The rendering engine RE controls also which 3D graphics will be converted to the image domain. Since the implementation of the collinearity equation requires significant computational resources per frame the rendering engine RE ensures that only relevant navigation information is overlaid onto the video feed VE. This is achieved by limiting the 3D rendering of the calculated route R as defined by the path calculator PC (FIG. 1) to a user specified radius. The same 3D rendering cut-off radius is imposed on the 3D map O (FIG. 6) so that only 3D buildings within this radius are rendered. In addition the user has the option to select which Points of Interest (POIs) will be displayed and this limits the rendering of 3D objects to that particular selection of POIs.

With the cut-off radius imposed, the renderer has to perform a visibility analysis only on a subset of 3D vertices. Only the 3D vertices visible from the current user's position are converted from the 3D object space to the image coordinate system as illustrated in FIG. 7.

Navigation, based on augmented-reality, is particularly suitable inside complex urban areas where precise directions are needed. In rural areas where navigation is simpler, an isometric (3D) or 2D conventional map display of navigation information CO is adopted (FIG. 1). The selection between the augmented-reality AR and conventional 3D perspective display CO can occur automatically (based on but not limited to the availability of POIs in the 3D map O and proximity to a destination D, or manually (user preference).

If the user selects the automatic transition between the AR and conventional 3D perspective view CO then the transition is based on the following criteria:

Within rural areas:
If POIs are enabled by the user and 3D buildings are visible from a user's current position and located within the specified radius then use AR, else use CO.
If user's position is within the specified radius of their destination D (FIG. 6) and 3D buildings are available then use AR, else use CO.

Within urban areas:
Always use AR unless no 3D buildings are available within the specified radius from a user's current position.

Note that distinction between rural and urban areas is enabled through the mapping data.

The invention claimed is:

1. A method for the display of navigation instructions, which have been generated as a function of a user defined destination, whereby the current position of the user is recorded using GNSS satellite systems, the orientation of the user is established through azimuth information from a GNSS sensor and a digital compass, the field of view in front of a user is recorded by a video camera and the video image is augmented for navigation by superimposing navigation instructions assembled using the output data from said sensors.

2. A method according to claim 1, where the navigation instructions are displayed as a function of the user's position and orientation using 3D mapping data with spatially varying vertical elevations including but not limited to 3D paths and 3D buildings, and can be related to the user visually, by drawing them onto the video image, as well as acoustically through street and landmark names.

3. A method according to claim 2, where the navigation path, which augments the live video feed, is drawn consistently using graphical semi-transparency to allow for objects or subjects which appear in front of the camera to be seen on the navigation screen also.

4. A method according to claim 2, where the horizontal positional accuracy of the user is enhanced by implementing a method which analyses the user's x,y position in relation to the available path network by computing the perpendicular distance to the nearest path section.

5. A method according to claim 2, where the vertical positional accuracy of the user is enhanced by calculating the user's height on the basis of the 3D path elevation plus a user defined height depending on either the type of vehicle used or a user's physical height.

6. A method where the field of view of the camera used for user navigation, is adjusted for correct superimposition of perspective navigation instructions by replicating the focal length, principal point and lens distortions of the video camera model in a graphical rendering engine.

7. A method where POI and user destination information along the driven path or navigation path are displayed through the use of “billboards”, which are projected onto the live video stream at their respective semantic location.

8. A method according to claim 1, where the navigation instructions are displayed on the screen of a portable device including but not limited to PDAs and smartphones, as well as on in-dash vehicle infotainment systems.
